(19) United States
(12) Patent Application Publication
(10) Pub. No.: US 2016/0045292 A1
(43) Pub. Date: Feb. 18, 2016

(54) DENTAL APPLIANCE CONTAINER HAVING A PLATFORM IN A MIDDLE PORTION FORMED USING A SERIES OF SLABS

(71) Applicant: Zachary Winer, Palo Alto, CA (US)

(72) Inventor: Zachary Winer, Palo Alto, CA (US)

(21) Appl. No.: 14/461,366

(22) Filed: Aug. 16, 2014

(51) Int. Cl. A61C 19/02; B08B 3/04; A61C 17/00

(52) U.S. Cl. CPC A61C 19/02; A61C 17/036; B08B 3/04

(57) ABSTRACT

A dental appliance container includes a top portion having a center cavity closeable using a strap affixed to a side of the top portion that the strap includes a member that can securely fasten to the center cavity when the top portion is made inaccessible to a liquid material. A platform within the middle portion formed using a series of slabs and the platform to permit a dental appliance to be stored on top of the platform such that the dental appliance is fully encapsulated in a cavity formed between the top portion and the middle portion. The liquid material to flow through the top portion to a location below the middle portion when the liquid material is deposited through the center cavity onto the dental appliance when the liquid material flows through the middle portion through the series of slabs to the location below the middle portion.

### FIELD OF THE TECHNOLOGY

This disclosure relates generally to the field of dental instruments, and more particularly, to a dental appliance container having a platform in a middle portion formed using a series of slabs.

### BACKGROUND

A dental appliance (e.g., a mouthguard, a retainer, a denture) may need periodic cleaning. For example, the dental appliance may need to be cleaned to prevent bacteria from forming on the dental appliance. A container in which the dental appliance is cleaned may encapsulate the dental appliance with a liquid material when the dental appliance is placed in the container. The bacteria may be stimulated by the encapsulation of the dental appliance with the liquid material. As a result, the bacteria may continue to grow on the dental appliance even when the dental appliance is in the container. This may create health and hygiene problems for a wearer of the dental appliance.

### SUMMARY

Disclosed are a method, a device and/or a system of a dental appliance container having a platform in a middle portion formed using a series of slabs.

In one aspect, a container includes a top portion having a center cavity that is closeable using a strap affixed to a side of the top portion such that the strap includes a member that can securely fasten to the center cavity when the top portion is made inaccessible to a liquid material. The container includes a middle portion, a platform within the middle portion formed using a series of slabs. The platform permits a dental appliance to be stored on top of the platform such that the dental appliance is fully encapsulated in a cavity formed between the top portion and the middle portion. The liquid material to flow through the top portion to a location below the middle portion when the liquid material is deposited through the center cavity onto the dental appliance when the liquid material flows through the middle portion through the series of slabs to the location below the middle portion. A lower portion may capture the liquid material that flows through the top portion to the location below the middle portion when the lower portion is affixed to the middle portion.

The dental appliance may be a retainer. The liquid material may be water, a vinegar solution and/or a cleaning solution of the retainer. The retainer may be rinsed using the water, the vinegar solution, and/or the cleaning solution when the water, the vinegar solution, and/or the cleaning solution may be deposited through the center cavity onto the retainer on top of the platform in the middle portion. The retainer may get dry when the water, the vinegar solution, and/or the cleaning solution to flow to the location below the middle portion.

The dental appliance may be a denture. The liquid material may be water, a vinegar solution, and/or a cleaning solution of the denture. The denture may be rinsed using the water, the vinegar solution, and/or the cleaning solution when the water, the vinegar solution, and/or the cleaning solution is deposited through the center cavity onto the denture on top of the platform in the middle portion. The denture may get dry when the water, the vinegar solution, and/or the cleaning solution to flow to the location below the middle portion.

The top portion, the middle portion, and/or the lower portion may be fastened together using a threaded patterning which permits the top portion to be affixed to the middle portion and/or the middle portion to be affixed to the lower portion using the threaded patterning.

The top portion, the middle portion, and/or the lower portion to each may have a rounded interior shape to provide for the easy cleaning of each of the top portion, the middle portion, and/or the lower portion. The top portion, the middle portion, and/or the lower portion may be formed using a thermoplastic elastomer material.

The top portion and/or the lower portion may have a concave shape on exterior surfaces of the top portion and/or the lower portion such that the concave shape continues to a junction between each of the top portions and the lower portion with the middle portion.

The dental appliance may be a mouthguard. The liquid material may be a hot water. The mouthguard may be prepared for forming when placed on top of the platform in the middle portion. The mouthguard may be rinsed using the hot water when the hot water is deposited through the center cavity onto the mouthguard on top of the platform in the middle portion. The mouthguard may get dry when the hot water to flow to the location below the middle portion.

An inner junction between an inner wall of the middle portion and the series of slabs forming the platform within the middle portion may be rounded to provide for easy cleaning of the inner junction between the inner wall of the middle portion and each of the series of slabs forming the platform within the middle portion.

A gap between each of the series of slabs may be wider than 0.63 inches to provide enough room for a human finger to traverse a length of each of the series of slabs during a manual cleaning process.

In another aspect, a container includes a top portion having a center cavity, a middle portion, a platform within the middle portion formed using a series of slabs and the platform to permit a dental appliance to be stored on top of the platform such that the dental appliance is fully encapsulated in a cavity formed between the top portion and the middle portion. The container also includes a liquid material to flow through the top portion to a location below the middle portion when the liquid material is deposited through the center cavity onto the dental appliance when the liquid material flows through the middle portion through the series of slabs to the location below the middle portion.

In yet another aspect, a container includes a top portion having a center cavity, a middle portion, a platform within the middle portion formed using a series of slabs and the platform to permit a dental appliance to be stored on top of the platform such that the dental appliance is fully encapsulated in a cavity formed between the top portion and the middle portion. A liquid material to flow through the top portion to a location below the middle portion when the liquid material is deposited through the center cavity onto the dental appliance when the liquid material flows through the middle portion through the series of slabs to the location below the middle portion. An inner junction between an inner wall of the middle portion and the series of slabs forming the platform within the middle portion is rounded to provide for easy cleaning of the inner junction between the inner wall of the middle portion and each of the series of slabs forming the platform within the middle portion. A gap between each of the series of slabs is wider than 0.63 inches to provide enough room for a human finger to traverse a length of each of the series of slabs during a manual cleaning process.

The methods and systems disclosed herein may be implemented in any means for achieving various aspects. Other features will be apparent from the accompanying drawings and from the detailed description that follows.

### BRIEF DESCRIPTION OF THE DRAWINGS

The embodiments of this invention are illustrated by way of example and not limitation in the Figures of the accompanying drawings, in which like references indicate similar elements and in which:

FIG. 1 is a front, an exploded front, and an exploded top view of a dental appliance container, according to one embodiment.

FIG. 2 is cross section view of the dental appliance container, according to one embodiment.

FIG. 3 is a front and top view showing the dimensions of one possible embodiment of the dental appliance container, according to one embodiment.

FIG. 4 is a perspective view of the dental appliance container, according to one embodiment.

FIG. 5 is a graphical process view showing the use of the dental appliance container to clean a retainer, according to one embodiment.

FIG. 6 is a graphical process view showing the use of the dental appliance container to prepare a mouthguard for forming, according to one embodiment.

Other features of the present embodiments will be apparent from the accompanying drawings and from the detailed description that follows.

### DETAILED DESCRIPTION

A method, apparatus, and system of a dental appliance container having a platform in a middle portion formed using a series of slabs are disclosed. In the following description, for the purposes of explanation, numerous specific details are set forth in order to provide a thorough understanding of the various embodiments. It will be evident, however, to one skilled in the art that the various embodiments may be practiced without these specific details.

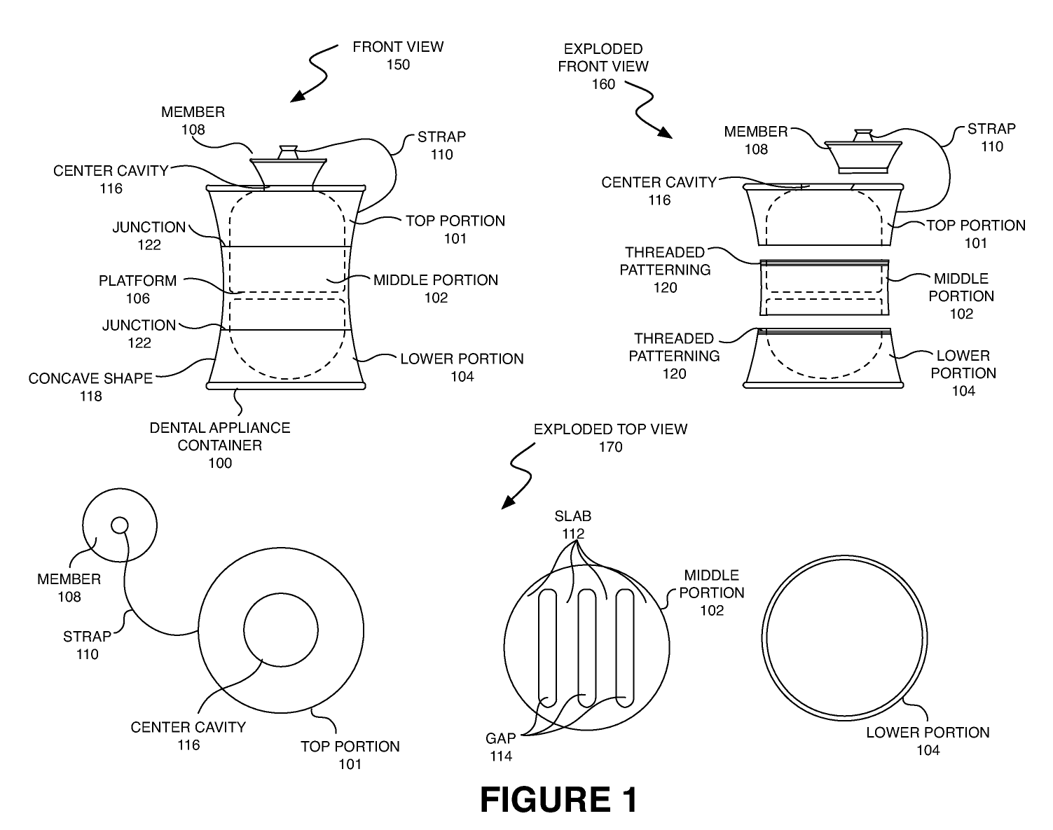

FIG. 1 is a front view 150, an exploded front view 160, and an exploded top view 170 of a dental appliance container 100, according to one embodiment. Particularly, FIG. 1 shows the dental appliance container 100, a top portion 101, a middle portion 102, a lower portion 104, a platform 106, a member 108, a strap 110, a slab 112, a gap 114, a center cavity 116, a concave shape 118, a threaded patterning 120, and a junction 122.

The dental appliance container 100 may be an object that can be used to hold a device or apparatus which may be placed in a person's mouth. Examples of dental appliances include, but are not limited to, retainers, dentures, and mouthguards. The top portion 101 may be a segment of the dental appliance container 100 which may be intended to be above the other portions. The middle portion 102 may be a segment of the dental appliance container 100 which may be situated between the top and lower portions. The lower portion 104 may be a segment of the dental appliance container 100 which may be intended to be below the other portions. The platform 106 may be a level surface within the dental appliance container 100 on which a dental appliance may rest. The member 108 may be a piece of material which may be used to close the center cavity 116 located on the top portion 101, such that liquid material 502 does not escape when the dental appliance container 100 is used. The strap 110 may be a narrow piece of material which connects the member 108 to the dental appliance container 100. The slab 112 may be a narrow, elongated piece of material which makes up the platform 106. The slabs 112 may connect with the interior of the middle portion 102 in one or more places. The gap 114 may be an open space between slabs 112. The center cavity 116 may be an opening in the top portion 101. The concave shape 118 may be an outer surface of the dental appliance container 100 which curves inward like the interior of a sphere. The threaded patterning 120 may be a helical ridge on the outside or inside of two parts, which may allow the two parts to be screwed together. The junction 122 may be where two portions meet.

As shown in FIG. 1, the member 108 is affixed to the strap 110, which is in turn affixed to the side of the top portion 101. Furthermore, the member 108 may be secured to the top portion 101 such that the center cavity 116 is sealed and is inaccessible to liquid material 502. In one embodiment, the member 108 may be secured to the top portion 101 through friction. Effervescent cleaning products, such as tablets, may release gas (e.g. carbon dioxide) when added to a liquid material 502. As an option, the seal created by friction between the member 108 and the center cavity 116 may be strong enough to prevent the release of liquid material 502 when in use, but not so strong that the use of effervescent cleaning products when the dental appliance container 100 is sealed would result in a dangerous sudden decompression (e.g. explosion). Specifically, in one embodiment, the member 108 may fit tight enough in the center cavity 116 that liquid material 502 will not leak when the container is shaken, but if the member 108 is inserted into the center cavity 116 after an effervescent tablet is used, it will simply pop out before dangerous pressure levels are produced. In another embodiment, the member 108 may be secured to the top portion 101 using a threaded patterning 120. In still another embodiment, the member 108 may be secured to the top portion 101 using one or more protruding tabs which prevent the member 108 from being removed from the center cavity 116 after being inserted and twisted. The one or more slabs 112 which make up the platform 106 are part of the middle portion 102. In various embodiments, the top portion 101 may be secured to the middle portion 102, and the middle portion 102 may be secured to the lower portion 104, through the use of a threaded patterning 120. The portions may be secured such that the junction 122 will not leak any liquid material 502 when the dental appliance container 100 is in use.

In one embodiment, a container includes a top portion 101 having a center cavity 116 that is closeable using a strap 110 affixed to a side of the top portion 101 such that the strap 110 includes a member 108 that can securely fasten to the center cavity 116 when the top portion 101 is made inaccessible to a liquid material 502. The container includes a middle portion 102, a platform 106 within the middle portion 102 formed using a series of slabs 112 and the platform 106 to permit a dental appliance to be stored on top of the platform 106 such that the dental appliance is fully encapsulated in a cavity 200 formed between the top portion 101 and the middle portion 102. The liquid material 502 to flow through the top portion 101 to a location below the middle portion 102 when the liquid material 502 is deposited through the center cavity 116 onto the dental appliance when the liquid material 502 flows through the middle portion 102 through the series of slabs 112 to the location below the middle portion 102.

A lower portion 104 may capture the liquid material 502 that flows through the top portion 101 to the location below the middle portion 102 when the lower portion 104 is affixed to the middle portion 102. The top portion 101, the middle portion 102, and/or the lower portion 104 may be fastened together using a threaded patterning 120 which permits the top portion 101 to be affixed to the middle portion 102 and/or the middle portion 102 to be affixed to the lower portion 104 using the threaded patterning 120. The top portion 101 and/or the lower portion 104 may have a concave shape 118 on exterior surfaces of the top portion 101 and/or the lower portion 104 such that the concave shape 118 continues to a junction 122 between each of the top portion 101s and the lower portion 104 with the middle portion 102.

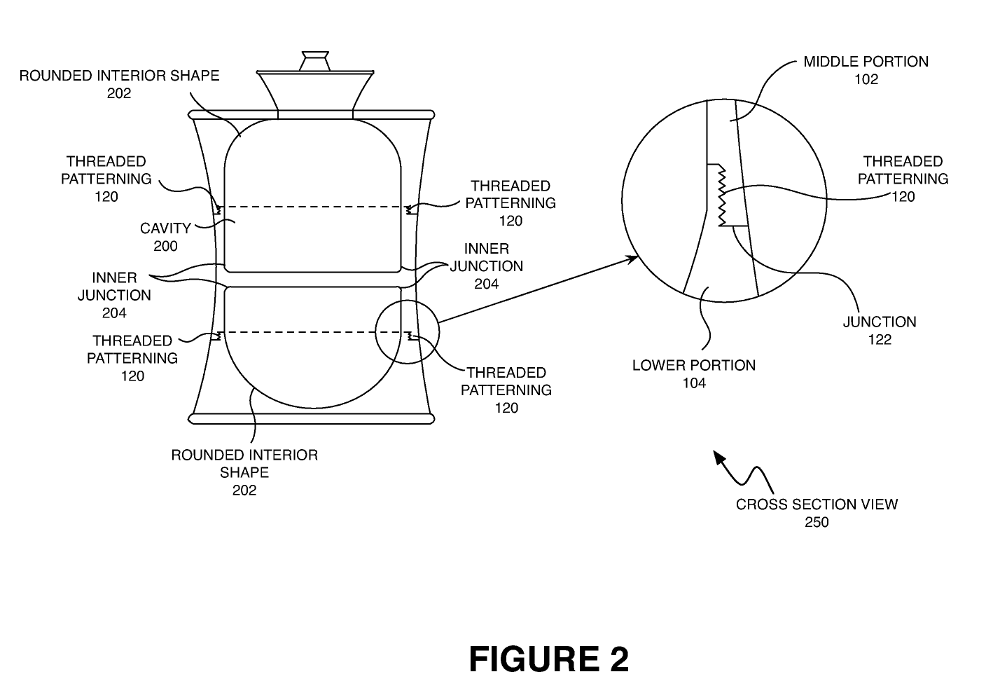

FIG. 2 is cross section view 250 of the dental appliance container 100, according to one embodiment. In particular, FIG. 2 shows a cavity 200, a rounded interior shape 202, and an inner junction 204, in addition to the threaded patterning 120, top portion 101, middle portion 102, lower portion 104, and junction 122 of FIG. 1.

The cavity 200 may be an empty space within the assembled dental appliance container 100 which may fully encapsulate a dental appliance which is resting on the platform 106. The rounded interior shape 202 may be a cavity within the dental appliance container 100 which lacks sharp corners. The inner junction 204 may be where an interior surface of the middle portion 102 meets with a slab 112.

As the dental appliance container 100 is used to clean a dental appliance, material which was previously stuck to the dental appliance may become free and subsequently become stuck to a surface of the interior of the dental appliance container 100. A container with internal corners may be difficult to clean; as material gathers in a corner, cleaning may require the use of an implement which can reach into the corner. This would increase the difficulty and inconvenience of cleaning the container. In various embodiments, the interior of the dental appliance container 100 may be without sharp corners to inhibit the collection of material and facilitate cleaning. See, for example, the rounded interior shape 202 of the cavity 200, as well as the rounded interior shape 202 of the space below the platform 106. Furthermore, according to one embodiment, the inner junctions 204 of the dental appliance container 100 are rounded, so that material is not likely to collect where the slab 112 meets the interior wall of the middle portion 102. This rounded shape may facilitate cleaning, and inhibit the collection of hard-to-remove material.

As shown, the cavity 200 may not be wider in the upper portion than it is in the middle portion 102, according to one embodiment. In another embodiment, the cavity 200 may be shaped such that it maximizes the volume while still retaining the rounded interior shape 202.

In one embodiment, the top portion 101, the middle portion 102, and/or the lower portion 104 may each have a rounded interior shape 202 to provide for the easy cleaning of each of the top portion 101, the middle portion 102, and/or the lower portion 104. The top portion 101, the middle portion 102, and/or the lower portion 104 may be formed using a thermoplastic elastomer material. An inner junction 204 between an inner wall of the middle portion 102 and the series of slabs 112 forming the platform 106 within the middle portion 102 may be rounded to provide for easy cleaning of the inner junction 204 between the inner wall of the middle portion 102 and each of the series of slabs 112 forming the platform 106 within the middle portion 102.

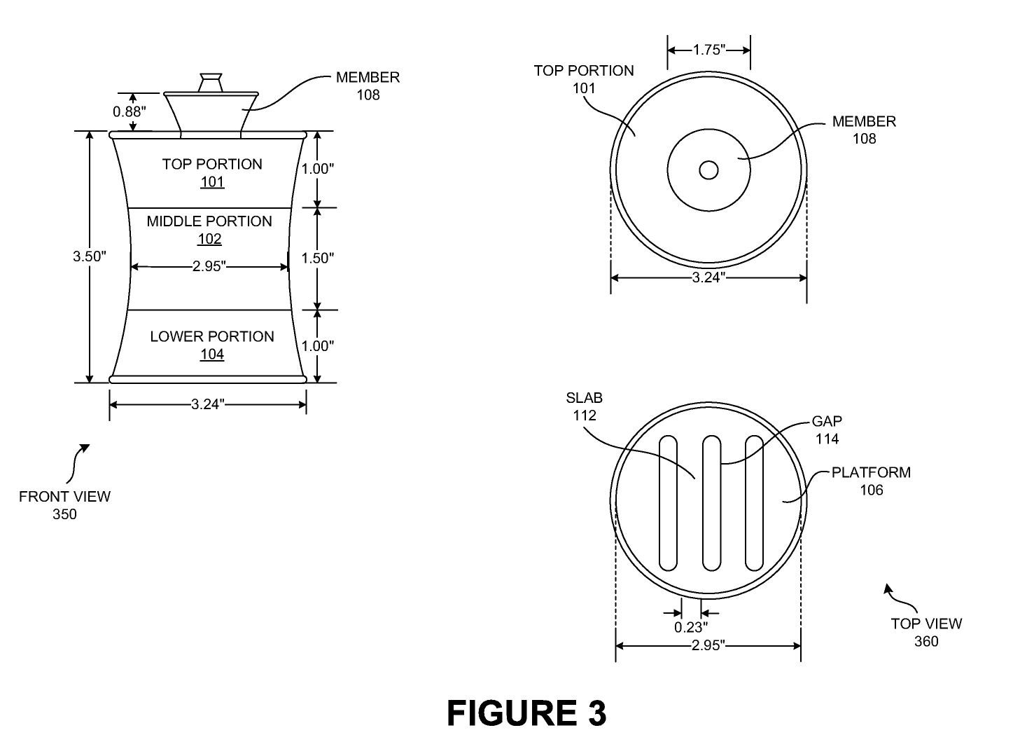

FIG. 3 is a front view 350 and top view 360 showing the dimensions of one possible embodiment of the dental appliance container 100, according to one embodiment. Particularly, FIG. 3 shows the top portion 101, the middle portion 102, the lower portion 104, the member 108, the slab 112, the gap 114, and the platform 106 of FIG. 1.

As shown, the assembled dental appliance container 100, with the member 108 secured inside the center cavity 116, is 4.38 inches tall and 3.24 inches wide, according to one embodiment. A preferred size for the dental appliance container 100 is one that provides a large enough interior to fully encapsulate a dental appliance, is easy to hold in one hand and shake, yet does not take up more room than necessary. In other embodiments, the size of the assembled dental appliance container 100 may be modified to give one attribute higher priority than another. For example, a variation of the dental appliance container 100 depicted in FIG. 3 which is optimized for travel may prioritize a minimization of volume over ease of holding in one hand. In another embodiment, a larger version may be made to make it easier to hold securely with a single, adult-sized hand.

Top view 360 shows the platform 106, according to one embodiment. From this view, the rounded nature of the inner junction 204 is evident. As shown, the width of a slab 112 in one possible embodiment is 0.23 inches. This is done so the gap 114 is large enough that a user may fit a finger inside, to facilitate cleaning. Over time, material may collect on the internal surfaces of the dental appliance container 100, requiring mechanical cleaning, as opposed to simply rinsing. Making the gap 114 large enough for an average sized finger to at least partially fit inside may make mechanical cleansing of the container much easier.

In one embodiment, the gap 114 between each of the series of slabs 112 may be wider than 0.63 inches to provide enough room for a human finger to traverse a length of each of the series of slabs 112 during a manual cleaning process.

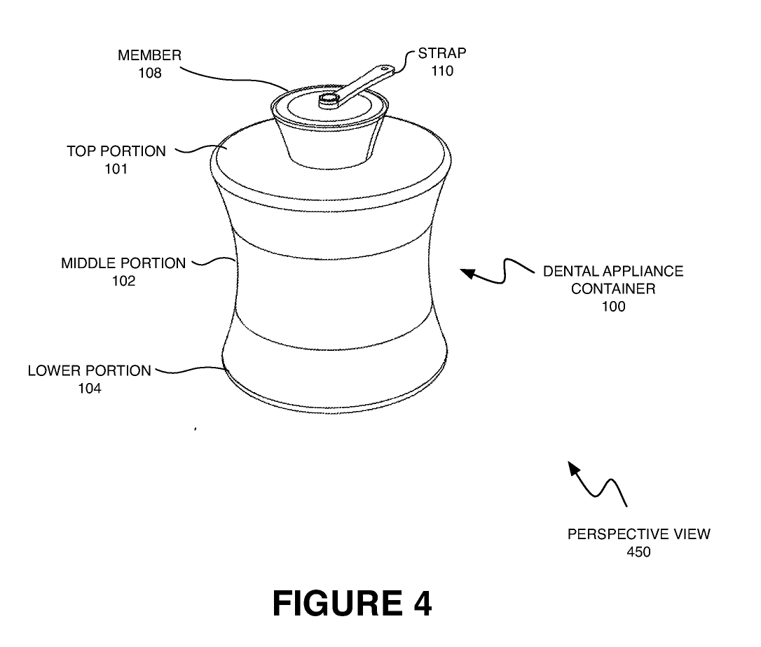

FIG. 4 is a perspective view 450 of the dental appliance container 100, according to one embodiment. Particularly, FIG. 4 shows the top portion 101, the middle portion 102, the lower portion 104, the member 108, and the strap 110 of the dental appliance container 100 of FIG. 1.

According to one embodiment, the top portion 101, the middle portion 102, and the lower portion 104 of the dental appliance container 100 may be made out of different materials. For example, in one embodiment, the dental appliance container 100 may be made out of a plastic, such as a thermoplastic elastomer. In the context of the present description, a thermoplastic elastomer may refer to a polymeric substance (e.g. synthetic resin, etc.) which may take on elastic properties when heated, and harden when cooled. Examples include acrylic (e.g. Lucite, Plexiglas, etc.), nylon, polyethylene, polybenzimidazole, polypropylene, polyvinyl chloride, and Teflon. Specific examples include Versa flex CL2242 and CL2250, both made by GLS.

In various embodiments, portions of the dental appliance container 100 may be made out of a thermoplastic elastomer which meets standards set for a dental apparatus (e.g. porosity, etc.), is durable (e.g. likely to survive being dropped on the hard surfaces often found in a bathroom, etc.), and has a low coefficient of expansion, such that the threaded patterning 120 will continue to fit property even when the container has been exposed to a heated liquid material 502. As an option, the material may also be dishwasher-safe, to facilitate the cleaning of the dental appliance container 100.

In one embodiment, the top portion 101, middle portion 102, and lower portion 104 of the dental appliance container 100 may be made of a thermoplastic elastomer formed using an injection molding process. In other embodiments, the container may be made using a different process, and may be made out of other materials, including, but not limited to, silicone, metal (e.g. medical grade stainless steel, etc.), and other forms of plastic (e.g. nylon, acrylic, etc.). In one embodiment, the dental appliance container 100 may be colored; in another embodiment, the top, middle, and lower portions of the container may be clear.

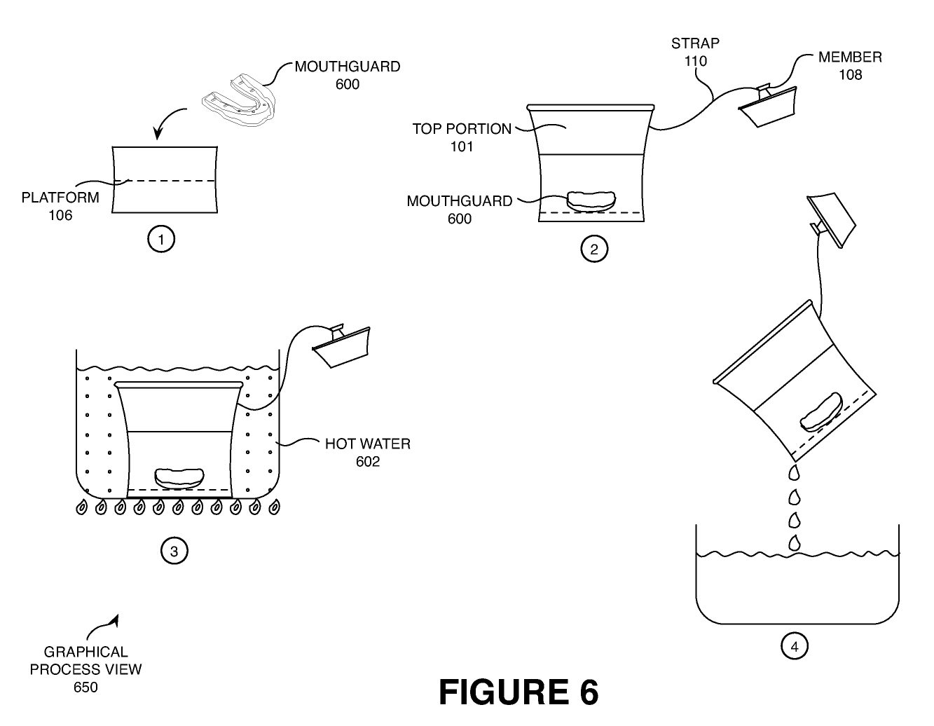

According to one embodiment, the member 108 and strap 110 may be made of the same material as the three portions of the dental appliance container 100. In another embodiment, the member 108 may be made of a material which has elastic properties, like a rubber. This may be advantageous in embodiments where the member 108 is secured in the center cavity 116 using friction. In yet another embodiment, the strap 110 may be made of a flexible, yet durable material which is strong enough to be used to remove the container from hot water 602 while filled with hot water 602 (see FIG. 6).

In one embodiment, the dental appliance container 100 may be made using injection molding. In another embodiment, the container may be made using a different process. In some embodiments, the space between the inner walls and outer surface of the container may be filled solid. In other embodiments, said space may be left hollow, to minimize the weight of the container (a consideration whose importance depends on what material is used to make the container.)

As shown, the dental appliance container 100 has a concave shape 118, which makes it easier to hold when shaking. In some embodiments, at least a part of the outer surface of the container may be covered with a material which is easy to grip, even when wet, such as some types of rubber. In other embodiments, at least a part of the outer surface of the container may be textured to facilitate a user's grip. In one embodiment, the bottom of the container may be covered in a non-slip material, to prevent the container from accidentally being knocked off of the often cramped working space in a bathroom.

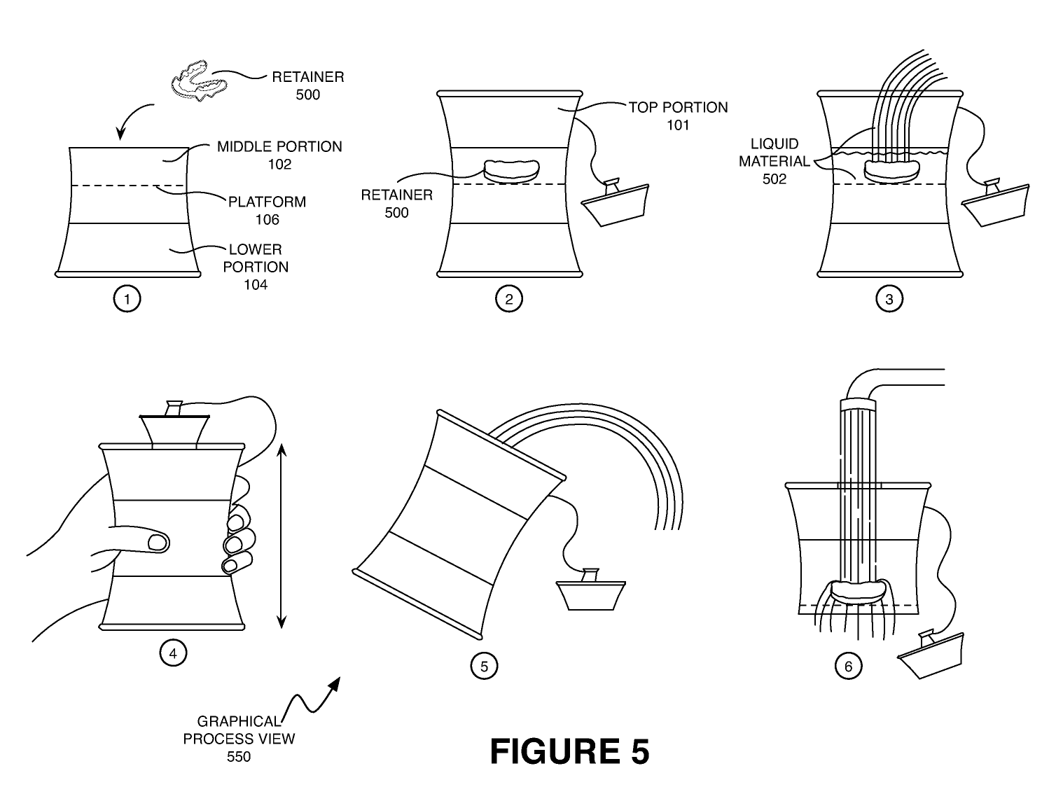

FIG. 5 is a graphical process view 550 showing the use of the dental appliance container 100 to clean a retainer 500, according to one embodiment. In particular, FIG. 5 shows the retainer 500 and a liquid material 502, in addition to the middle portion 102, the lower portion 104, the platform 106, the top portion 101, and the member 108 of FIG. 1.

The retainer 500 may be a dental appliance which may be used for keeping a loose tooth, an orthodontic prosthesis, or orthodontically aligned teeth in place. The liquid material 502 may be a material in a liquid state. Examples may include, but are not limited to, water, soap, cleaning solution, a vinegar solution, and/or any other liquid which could be used to clean the dental appliance.

FIG. 5 illustrates operations ‘circle 1’ through ‘circle 6’, depicting the use of the dental appliance container 100 to clean a dental appliance such as a retainer 500. First, in ‘circle 1’, the retainer 500 is placed on the platform 106 inside of the middle portion 102, while the lower portion 104 is secured to the middle portion 102. In ‘circle 2’, the top portion 101 is secured to the middle portion 102, fully encapsulating the retainer 500 inside the cavity 200. In ‘circle 3’, a liquid material 502 is added to the dental appliance container 100 through the center cavity 116. Next, in ‘circle 4’, the member 108 is secured inside the center cavity 116, and the closed container is shaken to clean the retainer 500. In one embodiment, the container may be shaken for ten seconds, then left alone for two minutes, allowing the retainer 500 to soak in the liquid material 502. After the soaking, the container may be shaken again for ten seconds. The amount of shaking, the vigor of the shaking, the number of shaking sessions, and the amount of soaking may vary from one embodiment to another, depending upon what liquid material 502 is being used to clean the retainer 500.

Next, in ‘circle 5’, the member 108 is removed and the liquid material 502 is poured out through the center cavity 116. Finally, in ‘circle 6’, the retainer 500 is rinsed in water. As shown, the lower portion 104 may be removed and running water may be directed through the center cavity 116, down onto the retainer 500, through the platform 106, and out the open bottom, in accordance with one embodiment. In another embodiment, the dental appliance container 100 may be refilled with water through the center cavity 116 (with all three portions secured), the member 108 may be replaced, and the container shaken for a few seconds to rinse the retainer 500. Thereafter, the rinsing water may be poured out. In various embodiments, the container may be used to store a retainer 500, or other dental appliance.

In one embodiment, the dental appliance may be used to clean a dental appliance, such as a retainer 500, using an effervescent tablet. In such a scenario, the tablet would be placed in the lower portion 104, after which the middle portion 102 would be secured to the lower portion 104. The retainer 500 would be placed on the platform 106 and the top portion 101 would be secured. The container would be filled with water or some other liquid through the center cavity 116, at least until the retainer 500 is submerged. The member 108 would not be secured to the center cavity 116, to prevent a dangerous buildup of pressure generated by the effervescent tablet. After a sufficient amount of time (as determined by the manufacture and specification of the effervescent tablet), the liquid material 502 inside the container would be poured out, and the retainer 500 would be rinsed using procedures previously described.

In one embodiment, the dental appliance may be a retainer 500. The liquid material 502 may be water, a vinegar solution and/or a cleaning solution of the retainer 500. The retainer 500 may be rinsed using the water, the vinegar solution, and/or the cleaning solution when the water, the vinegar solution, and/or the cleaning solution may be deposited through the center cavity 116 onto the retainer 500 on top of the platform 106 in the middle portion 102. The retainer 500 may get dry when the water, the vinegar solution, and/or the cleaning solution to flow to the location below the middle portion 102.

In another embodiment, the dental appliance may be a denture. The liquid material 502 may be water, a vinegar solution, and/or a cleaning solution of the denture. The denture may be rinsed using the water, the vinegar solution, and/or the cleaning solution when the water, the vinegar solution, and/or the cleaning solution is deposited through the center cavity 116 onto the denture on top of the platform 106 in the middle portion 102. The denture may get dry when the water, the vinegar solution, and/or the cleaning solution to flow to the location below the middle portion 102.

FIG. 6 is a graphical process view 650 showing the use of the dental appliance container 100 to prepare a mouthguard 600 for forming, according to one embodiment. Particularly, FIG. 6 shows the mouthguard 600 and hot water 602, in addition to the middle portion 102, the platform 106, the top portion 101, the member 108, and the strap 110 of FIG. 1.

The mouthguard 600 may be a protective device for the mouth that covers the teeth and gums to prevent and reduce injury to the teeth, arches, lips and gums, often used in conjunction 122 with a contact sport. The hot water 602 may be water whose temperature is between room temperature and boiling, and is sufficient to render the mouthguard 600 at least partially elastic, in accordance with the manufacture and specification of the mouthguard 600.

FIG. 6 illustrates operations ‘circle 1’ through ‘circle 4’, depicting the use of the dental appliance container 100 to prepare a mouthguard 600 for forming. First, in ‘circle 1’, the mouthguard 600 is placed on the platform 106 inside the middle portion 102; the lower portion 104 is not secured to the middle portion 102. In ‘circle 2’, the top portion 101 is secured to the middle portion 102, fully encapsulating the mouthguard 600 inside the cavity 200. The member 108 is not secured to the center cavity 116.

Next, in ‘circle 3’, the member 108 and strap 110 are used to lower the top and middle portions containing the mouthguard 600 into the hot water 602. The member 108 and strap 110 are used to prevent the user from being exposed to the hot water 602. Finally, after the mouthguard 600 has been exposed to the hot water 602 for a sufficient amount of time (as determined by the manufacture and specification of the mouthguard 600), the member 108 and strap 110 are used to lift the container out of the hot water 602, allowing it to drain. See ‘circle 4’. Thereafter, the mouthguard 600 is formed to the user's mouth and teeth, in accordance with the instructions that accompanied the mouthguard 600.

In one embodiment, the dental appliance may be a mouthguard 600. The liquid material 502 may be a hot water 602. The mouthguard 600 may be prepared for forming when placed on top of the platform 106 in the middle portion 102. The mouthguard 600 may be rinsed using the hot water 602 when the hot water 602 is deposited through the center cavity 116 onto the mouthguard 600 on top of the platform 106 in the middle portion 102. The mouthguard 600 may get dry when the hot water 602 to flow to the location below the middle portion 102.

In another embodiment, a container includes a top portion 101 having a center cavity 116, a middle portion 102, a platform 106 within the middle portion 102 formed using a series of slabs 112 and the platform 106 to permit a dental appliance from being stored on top of the platform 106 such that the dental appliance is fully encapsulated in a cavity 200 formed between the top portion 101 and the middle portion 102. The container also allows a liquid material 502 to flow through the top portion 101 to a location below the middle portion 102 when the liquid material 502 is deposited through the center cavity 116 onto the dental appliance when the liquid material 502 flows through the middle portion 102 through the series of slabs 112 to the location below the middle portion 102.

In yet another embodiment, a container includes a top portion 101 having a center cavity 116, a middle portion 102, a platform 106 within the middle portion 102 formed using a series of slabs 112 and the platform 106 to permit a dental appliance to be stored on top of the platform 106 such that the dental appliance is fully encapsulated in a cavity 200 formed between the top portion 101 and the middle portion 102. The container also allows a liquid material 502 to flow through the top portion 101 to a location below the middle portion 102 when the liquid material 502 is deposited through the center cavity 116 onto the dental appliance when the liquid material 502 flows through the middle portion 102 through the series of slabs 112 to the location below the middle portion 102.

An inner junction 204 between an inner wall of the middle portion 102 and the series of slabs 112 forming the platform 106 within the middle portion 102 is rounded to provide for easy cleaning of the inner junction 204 between the inner wall of the middle portion 102 and each of the series of slabs 112 forming the platform 106 within the middle portion 102. A gap 114 between each of the series of slabs 112 is wider than 0.63 inches to provide enough room for a human finger to traverse a length of each of the series of slabs 112 during a manual cleaning process.

A number of embodiments have been described. Nevertheless, it will be understood that various modifications may be made without departing from the spirit and scope of the claimed invention. In addition, the logic flows depicted in the Figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A container comprising:
a top portion having a center cavity that is closeable using a strap affixed to a side of the top portion such that the strap includes a member that can securely fasten to the center cavity when the top portion is made inaccessible to a liquid material;
a middle portion; and
a platform within the middle portion formed using a series of slabs,
wherein the platform to permit a dental appliance to be stored on top of the platform such that the dental appliance is fully encapsulated in a cavity formed between the top portion and the middle portion, and
wherein the liquid material to flow through the top portion to a location below the middle portion when the liquid material is deposited through the center cavity onto the dental appliance when the liquid material flows through the middle portion through the series of slabs to the location below the middle portion.

2. The container of claim 1 further comprising:
a lower portion to capture the liquid material that flows through the top portion to the location below the middle portion when the lower portion is affixed to the middle portion.

3. The container of claim 2:
wherein the dental appliance is at least one of a retainer;
wherein the liquid material is at least one of a water, a vinegar solution, and a cleaning solution of the retainer;
wherein the retainer is rinsed using at least one of the water, the vinegar solution, and the cleaning solution when at least one of the water, the vinegar solution, and the cleaning solution is deposited through the center cavity onto the retainer on top of the platform in the middle portion, and
wherein the retainer is dried when at least one of the water, the vinegar solution, and the cleaning solution to flow to the location below the middle portion.

4. The container of claim 2:
wherein the dental appliance is at least one of a denture;
wherein the liquid material is at least one of a water, a vinegar solution, and a cleaning solution of the denture;
wherein the denture is rinsed using at least one of the water, the vinegar solution, and the cleaning solution when at least one of the water, the vinegar solution, and the cleaning solution is deposited through the center cavity onto the denture on top of the platform in the middle portion, and
wherein the denture is dried when at least one of the water, the vinegar solution, and the cleaning solution to flow to the location below the middle portion.

5. The container of claim 2:
wherein the top portion, the middle portion, and the lower portion are fastened together using a threaded patterning that permits the top portion to be affixed to the middle portion and the middle portion to be affixed to the lower portion using the threaded patterning.

6. The container of claim 2:
wherein the top portion, the middle portion, and the lower portion to each have a rounded interior shape to provide for the easy cleaning of each of the top portion, the middle portion, and the lower portion, and
wherein the top portion, the middle portion, and the lower portion are formed using a thermoplastic elastomer material.

7. The container of claim 2:
wherein the top portion and the lower portion have a concave shape on exterior surfaces of the top portion and the lower portion such that the concave shape continues to at least a junction between each of the top portion and the lower portion with the middle portion.

8. The container of claim 1:
wherein the dental appliance is a mouthguard,
wherein the liquid material is a hot water,
wherein the mouthguard is prepared for forming when placed on top of the platform in the middle portion,
wherein the mouthguard is rinsed using the hot water when the hot water is deposited through the center cavity onto the mouthguard on top of the platform in the middle portion, and
wherein the mouthguard is dried when the hot water to flow to the location below the middle portion.

9. The container of claim 1:
wherein an inner junction between an inner wall of the middle portion and the series of slabs forming the platform within the middle portion is rounded to provide for easy cleaning of the inner junction between the inner wall of the middle portion and each of the series of slabs forming the platform within the middle portion.

10. The container of claim 1:
wherein a gap between each of the series of slabs is wider than a 0.63 inches to provide enough room for a human finger to traverse a length of each of the series of slabs during a manual cleaning process.

11. A container comprising:
a top portion having a center cavity;
a middle portion; and
a platform within the middle portion formed using a series of slabs,
wherein the platform to permit a dental appliance to be stored on top of the platform such that the dental appliance is fully encapsulated in a cavity formed between the top portion and the middle portion, and
wherein a liquid material to flow through the top portion to a location below the middle portion when the liquid material is deposited through the center cavity onto the dental appliance when the liquid material flows through the middle portion through the series of slabs to the location below the middle portion.

12. The container of claim 11 further comprising:
a lower portion to capture the liquid material that flows through the top portion to the location below the middle portion when the lower portion is affixed to the middle portion.

13. The container of claim 12:
wherein the dental appliance is at least one of a retainer;
wherein the liquid material is at least one of a water, a vinegar solution, and a cleaning solution of the retainer;
wherein the retainer is rinsed using at least one of the water, the vinegar solution, and the cleaning solution when at least one of the water, the vinegar solution, and the cleaning solution is deposited through the center cavity onto the retainer on top of the platform in the middle portion, and
wherein the retainer is dried when at least one of the water, the vinegar solution, and the cleaning solution to flow to the location below the middle portion.

14. The container of claim 12:
wherein the dental appliance is at least one of a denture;
wherein the liquid material is at least one of a water, a vinegar solution, and a cleaning solution of the denture;
wherein the denture is rinsed using at least one of the water, the vinegar solution, and the cleaning solution when tat least one of the water, the vinegar solution, and the cleaning solution is deposited through the center cavity onto the denture on top of the platform in the middle portion, and
wherein the denture is dried when at least one of the water, the vinegar solution, and the cleaning solution to flow to the location below the middle portion.

15. The container of claim 12:
wherein the top portion, the middle portion, and the lower portion are fastened together using a threaded patterning that permits the top portion to be affixed to the middle portion and the middle portion to be affixed to the lower portion using the threaded patterning.

16. A container comprising:
a top portion having a center cavity;
a middle portion; and
a platform within the middle portion formed using a series of slabs,
wherein the platform to permit a dental appliance to be stored on top of the platform such that the dental appliance is fully encapsulated in a cavity formed between the top portion and the middle portion,
wherein a liquid material to flow through the top portion to a location below the middle portion when the liquid material is deposited through the center cavity onto the dental appliance when the liquid material flows through the middle portion through the series of slabs to the location below the middle portion,
wherein an inner junction between an inner wall of the middle portion and the series of slabs forming the platform within the middle portion is rounded to provide for easy cleaning of the inner junction between the inner wall of the middle portion and each of the series of slabs forming the platform within the middle portion, and
wherein a gap between each of the series of slabs is wider than a 0.63 inches to provide enough room for a human finger to traverse a length of each of the series of slabs during a manual cleaning process.

17. The container of claim 16 further comprising:
a lower portion to capture the liquid material that flows through the top portion to the location below the middle portion when the lower portion is affixed to the middle portion.

18. The container of claim 17:
wherein the dental appliance is at least one of a retainer;
wherein the liquid material is at least one of a water, a vinegar solution, and a cleaning solution of the retainer;
wherein the retainer is rinsed using at least one of the water, the vinegar solution, and the cleaning solution when at least one of the water, the vinegar solution, and the cleaning solution is deposited through the center cavity onto the retainer on top of the platform in the middle portion, and
wherein the retainer is dried when at least one of the water, the vinegar solution, and the cleaning solution to flow to the location below the middle portion.

19. The container of claim 17:
wherein the dental appliance is at least one of a denture;
wherein the liquid material is at least one of a water, a vinegar solution, and a cleaning solution of the denture;
wherein the denture is rinsed using at least one of the water, the vinegar solution, and the cleaning solution when tat least one of the water, the vinegar solution, and the cleaning solution is deposited through the center cavity onto the denture on top of the platform in the middle portion, and
wherein the denture is dried when at least one of the water, the vinegar solution, and the cleaning solution to flow to the location below the middle portion.

20. The container of claim 17:
wherein the top portion, the middle portion, and the lower portion are fastened together using a threaded patterning that permits the top portion to be affixed to the middle portion and the middle portion to be affixed to the lower portion using the threaded patterning.
